(19) United States
(12) Patent Application Publication
(10) Pub. No.: US 2026/0218870 A1
(43) Pub. Date: Jul. 30, 2026

(54) OPTICAL ILLUMINATION ASSEMBLY, LIGHTING DEVICE AND MOTOR VEHICLE

(71) Applicant: VALEO VISION, Bobigny (FR)

(72) Inventors: Lu BAI, Wuhan (CN); Rong ZHOU, Wuhan (CN)

(73) Assignee: VALEO VISION, Bobigny (FR)

(21) Appl. No.: 19/141,095

(22) PCT Filed: Dec. 20, 2023
(86) PCT No.: PCT/CN2023/140116

§ 371 Date: Jun. 19, 2025

(30) Foreign Application Priority Data
Dec. 22, 2022 (CN) 202223451674.2

(51) Int. Cl. F21S 41/147; F21S 41/32

(52) U.S. Cl. CPC F21S 41/147; F21S 41/32

(57) ABSTRACT

The present invention discloses an optical illumination assembly (100), said optical illumination assembly comprising: a light source (10) and a printed circuit board (20), the light source being arranged on the printed circuit board and emitting light; a light reflector (30), the light reflector being provided with a reflective surface, the reflective surface being configured to collect light emitted by the light source (10), and reflect the light in a light beam along an optical axis of the optical illumination assembly (100); and an optical projection apparatus (40), the optical projection apparatus being configured to project the light beam, wherein the light source (10) is provided with a main light-emitting range, and the printed circuit board (20) is inclined towards the light reflector (30) relative to the optical axis, to prevent light emitted by the light source within the main light-emitting range from directly reaching the optical projection apparatus (40) and being projected.

### TECHNICAL FIELD

The present invention relates to an optical illumination assembly, a lighting device and a motor vehicle.

### BACKGROUND OF THE INVENTION

Lighting devices are used to provide light for lighting and/or optical indication functions, widely applicable in various fields. For example, lighting apparatuses such as vehicle lamps are used in motor vehicles to ensure safe driving. In motor vehicles, various types of vehicle lamps are often required to implement different functions, comprising a vehicle headlight, fog light, tail light, turn signals, brake light, side marker light, parking light, etc.

In lighting device design, interference light impairs a lighting effect or indication function, and therefore it is necessary to prevent interference light from appearing. A method of the prior art is to use a light shielding element to block interference light. However, a light shielding element may form dark zones, and increases vehicle lamp costs. A vehicle lamp design which better reduces interference light is required.

### SUMMARY OF THE INVENTION

The purpose of the present invention is to provide an optical illumination assembly, a lighting device and a motor vehicle, wherein said optical illumination assembly can prevent interference light from appearing without using a light shielding element, thereby improving a lighting effect.

In one aspect, an embodiment of the present invention provides an optical illumination assembly, said optical illumination assembly comprising: a light source and a printed circuit board, the light source being arranged on the printed circuit board and emitting light; a light reflector, the light reflector being provided with a reflective surface, the reflective surface being configured to collect light emitted by the light source, and reflect the light in a light beam along an optical axis of the optical illumination assembly; and an optical projection apparatus, the optical projection apparatus being configured to project the light beam, wherein the light source is provided with a main light-emitting range, and the printed circuit board is inclined towards the light reflector relative to the optical axis, to prevent light emitted by the light source within the main light-emitting range from directly reaching the optical projection apparatus and being projected.

In an embodiment, the main light-emitting range of the light source is between a light-emitting range of 120 degrees and a light-emitting range of 180 degrees.

In an embodiment, in a plane jointly defined by a normal line of the printed circuit board and the optical axis, the main light-emitting range of the light source is defined by a first light boundary and a second light boundary, wherein the second light boundary is closer to the optical projection apparatus, and the second light boundary is inclined towards the light reflector relative to a connecting line of the light source and an edge of an effective area of the optical projection apparatus, or coincides with the connecting line of the light source and the edge of the effective area of the optical projection apparatus.

In an embodiment, the printed circuit board is inclined 1 degree to 15 degrees relative to the optical axis.

In an embodiment, a focus region of the optical projection apparatus is at a rear edge of the reflective surface of the light reflector or in the vicinity thereof.

In an embodiment, the light reflector has a parabolic contour or an elliptical contour.

In an embodiment, a light beam projected by the optical projection apparatus forms a light distribution of a low beam function and/or high beam function.

In another aspect, an embodiment of the present invention provides a lighting device, said lighting device comprising the optical illumination assembly according to an embodiment of the present invention.

In another aspect, an embodiment of the present invention provides a motor vehicle, said motor vehicle comprising the optical illumination assembly according to an embodiment of the present invention, or the lighting device according to an embodiment of the present invention.

### BRIEF DESCRIPTION OF THE DRAWINGS

FIG. 1 shows a schematic diagram of an optical illumination assembly according to an embodiment of the present invention.

FIG. 2 shows a schematic diagram of the optical illumination assembly according to another embodiment of the present invention.

FIG. 3 shows a schematic diagram of an optical path of the optical illumination assembly according to an embodiment of the present invention.

### DETAILED DESCRIPTION OF THE INVENTION

The technical solution of the present invention is described in further detail below by means of embodiments with reference to the drawings. In this description, identical or similar reference signs denote identical or similar components. The following description of embodiments of the present invention with reference to the drawings are intended to explain the overall invention concept of the present invention, and should not be interpreted as a limitation of the present invention.

In addition, in the following detailed description, to facilitate explanation, many specific details are expounded for a comprehensive understanding of the embodiments of the present disclosure. However, it is evident that one or more embodiments may also be implemented without these specific details.

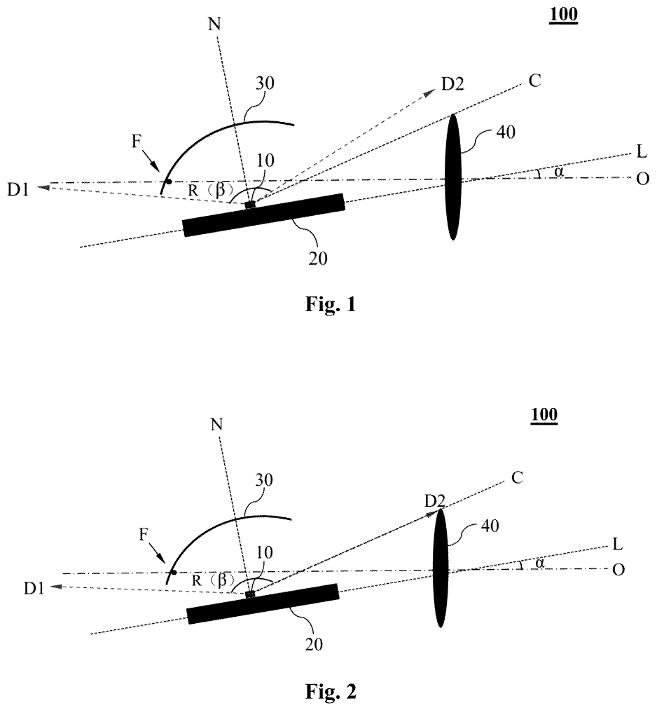

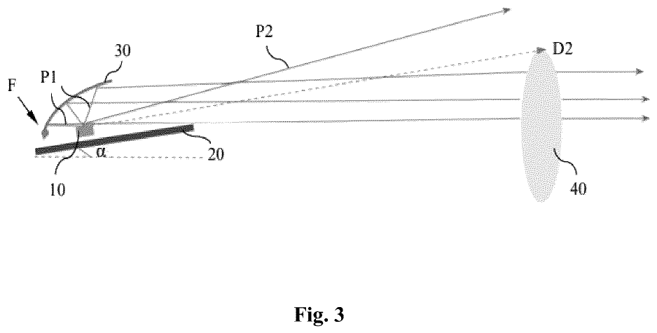

FIGS. 1-2 show an optical illumination assembly 100 according to different embodiments of the present invention. FIG. 3 shows a schematic diagram of an optical path of the optical illumination assembly 100 according to an embodiment of the present invention.

As shown in FIGS. 1-3, the optical illumination assembly 100 comprises a light source 10, a printed circuit board 20, a light reflector 30 and an optical projection apparatus 40. According to an embodiment of the present disclosure, the light source 10 is arranged on the printed circuit board 20 and emits light. As an example, the light reflector 30 is provided with a reflective surface, and said reflective surface may be used for collecting light emitted by the light source 10, and reflecting the collected light in a light beam along an optical axis O of the optical illumination assembly 100. The optical projection apparatus 40 may be used for projecting said light beam, to form a lighting light beam for example.

The light source 10 may have a main light-emitting range R. Herein the term “main light-emitting range R” may refer to a main concentrated region of light emitted by the light source 10. That is, light emitted by the light source 10 within the main light-emitting range R may have a certain influence on an optical effect or lighting effect of the optical illumination assembly 100, and light emitted by the light source 10 outside the main light-emitting range R may have almost no influence on the optical effect or lighting effect, or the influence may be discounted as negligible. In an embodiment, regarding a situation in which a light-emitting diode (LED) is used as a light source, an emission angle of the LED may be seen as the main light-emitting range of the light source, for example.

Furthermore, according to an embodiment of the present disclosure, the printed circuit board 20 is inclined towards the light reflector 30 relative to the optical axis O, to prevent the light emitted by the light source 10 within the main light-emitting range R from directly reaching the optical projection apparatus 40 and thus being projected by the optical projection apparatus 40. In some embodiments, here “the light emitted by the light source 10 within the main light-emitting range R . . . directly reaching the optical projection apparatus 40” may be understood as the light emitted by the light source 10 within the main light-emitting range R reaching the optical projection apparatus 40 without being reflected by the light reflector 30. By the above means, the appearance of interference light may be prevented. Herein “interference light” may refer to light which is emitted from the light source 10 but which does not meet the reflective surface of the light reflector 30. This type of interference light may participate in the light beam and light up part of the light beam, with the result of influencing a lighting effect of the optical illumination assembly 100, and therefore the appearance of interference light is undesired. Therefore, when the printed circuit board 20 is arranged at an incline as shown in FIG. 1, the main light-emitting range R of the light source 10 on the printed circuit board 20 is correspondingly also inclined. Thus, the main light-emitting range R of the light source 10 may be made to deviate from the optical projection apparatus 40, thereby enabling light emitted within the main light-emitting range R to reach a region outside the optical projection apparatus 40 when not reflected by the light reflector 30, thus avoiding projection by the optical projection apparatus 40.

In addition, compared with a situation in which the printed circuit board 20 is arranged parallel to the optical axis O, when the printed circuit board 20 is inclined towards the light reflector 30, it is further possible to cause more of the light within the main light-emitting range R of the light source 10 to be collected by the light reflector 30, so that it is possible to increase the lighting brightness of the optical illumination assembly 100, and increase optical efficiency. As shown in FIG. 3, most of the light emitted by the light source 10 within the main light-emitting range R advances along, for example, a first optical path P1, to be collected and reflected by the light reflector 30. The remaining smaller amount of light emitted within the main light-emitting range R may advance along, for example, a second optical path P2. The light advancing along the second optical path P2 is not collected by the light reflector 30; however, due to the inclined arrangement of the printed circuit board 20, said light also does not reach the optical projection apparatus 40 to be projected.

As an example, the printed circuit board 20 may have a normal line N. In a plane jointly defined by the normal line N and optical axis O, the main light-emitting range R of the light source 10 may be defined by a first light boundary D1 and a second light boundary D2. The second light boundary D2 is a boundary closer to the optical projection apparatus 40. As described above, the printed circuit board 20, of the optical illumination assembly 100 according to an embodiment of the present disclosure, is inclined towards the light reflector 30 relative to the optical axis O, so that the main light-emitting range R of the light source 10 does not intersect the optical projection apparatus 40. Therefore, the second light boundary D2 of the main light-emitting range R also does not intersect the optical projection apparatus 40. As an example, as shown in FIG. 1, the second light boundary D2 may be inclined towards the light reflector 30 relative to a connecting line C of the light source 10 and an edge (for example, an edge of a light-permeable part of the optical projection apparatus) of an effective area of the optical projection apparatus 40. This may ensure that light directly emitted from the light source 10 falls outside the optical projection apparatus 40. Optionally, as shown in FIG. 2, the second light boundary D2 may coincide with the connecting line C, to prevent excessive inclination of the printed circuit board 20.

As an example, the main light-emitting range R of the light source 10 may be between a light-emitting range of 120 degrees and a light-emitting range of 180 degrees. That is, a range of an angle β of the main light-emitting range R may be between a range of 120 degrees and a range of 180 degrees. In this way, when the main light-emitting range R has a light-emitting range of 180 degrees, for example, it is possible to ensure that none of the light emitted by the light source 10 directly reaches the optical projection apparatus 40, and thus maximally prevent the appearance of interference light and effectively improve a lighting effect.

As an example, the printed circuit board 20 may be inclined 1 degree to 15 degrees relative to the optical axis O. That is, a range of an angle α between an extended line L of the printed circuit board 20 and the optical axis O is between 1 degree and 15 degrees. Thus, without excessively affecting the arrangement of a surrounding structure or with barely any effect thereon, light of the light source 10 on the printed circuit board 20 may be prevented from directly reaching the optical projection apparatus 40.

As an example, the optical projection apparatus 40 has a focus region F, and said focus region F is at a rear edge of the reflective surface of the light reflector 30 or in the vicinity thereof. In this way, the rear edge of the reflective surface of the light reflector 30 may perform imaging, and thus produces a distinct cut-off part, thereby having a good lighting effect and illuminating effect.

As an example, the light reflector 30 may have a parabolic contour or an elliptical contour. In this way, the reflective surface of the light reflector 30 may correspondingly have a parabolic contour or an elliptical contour, that is, the reflective surface may be a rotated surface of said contour, specifically a surface obtained by rotation around an axis parallel to the optical axis. The term “parabolic” generally applies to a light reflector having a surface with a single focus (that is, one focusing region of light, which is to say, a region which causes light emitted by a light source placed in said focusing region to be projected to a remote distance after being reflected by the surface). “Projected to a remote distance” means that said light does not converge to a region located at a distance at least 10 times the size of the light reflector. In other words, the reflected light does not focus to a focusing region; alternatively, if the reflected light focuses, the focusing region is located at a distance greater than or equal to 10 times the size of the light reflector. Therefore, the parabolic surface may have a feature of a parabolic section or may not have the feature of a parabolic section. A light reflector having this type of surface is generally used individually to produce a light beam. Alternatively, it may act as a projection surface associated with a light reflector having an elliptical contour. In this type of situation, a light source of a light reflector having a parabolic contour is a focusing region of light reflected by a light reflector having an elliptical contour.

As an example, a light beam projected by the optical projection apparatus 40 may form a light distribution of a low beam function and/or high beam function. Specifically, a light beam projected by the optical projection apparatus 40 which has been reflected by the light reflector 30 may form a lighting light beam, such as a low-beam light beam, a high-beam light beam, or a segmented high-beam light beam of a linear array type having parallel vertical strips. In this way, the optical illumination assembly 100 according to an embodiment of the present disclosure can be used in a vehicle headlight to produce a low beam, or used to produce a high beam which is possibly segmented. However, the present disclosure is not limited to this. For example, the optical illumination assembly 100 according to an embodiment of the present disclosure also may be designed for executing a signalling function, for example being a direction indicator, a daytime running lamp or a positioning lamp, etc.

As an example, the light source 10 may be a semiconductor light source, and in particular a light-emitting diode (LED). However, the embodiments of the present invention are not limited to this.

As an example, the optical projection apparatus 40 may be a transmissive lens. However, the embodiments of the present invention are not limited to this.

Although the present invention has been explained in conjunction with the drawings, the embodiments disclosed in the drawings are intended to provide an illustrative description of preferred embodiments of the present invention, and cannot be interpreted as a limitation of the present invention.

Although some embodiments of the general concept of the present invention have been shown and described, those ordinarily skilled in the art will understand that changes can be made to these embodiments without departing from the principle and spirit of the general concept of the present invention. The scope of the present invention is defined by the claims and their equivalents.

What is claimed is:

1. An optical illumination assembly, comprising:
a light source and a printed circuit board the light source being arranged on the printed circuit board and emitting light;
a light reflector, the light reflector being provided with a reflective surface, the reflective surface being configured to collect light emitted by the light source, and reflect the light in a light beam along an optical axis of the optical illumination assembly; and
an optical projection apparatus the optical projection apparatus being configured to project the light beam,
wherein the light source is provided with a main light-emitting range, and the printed circuit board is inclined towards the light reflector relative to the optical axis, to prevent light emitted by the light source within the main light-emitting range from directly reaching the optical projection apparatus and being projected.

2. The optical illumination assembly according to claim 1, wherein the main light-emitting range of the light source is between a light-emitting range of 120 degrees and a light-emitting range of 180 degrees.

3. The optical illumination assembly according to claim 2, wherein in a plane jointly defined by a normal line of the printed circuit board and the optical axis, the main light-emitting range of the light source is defined by a first light boundary and a second light boundary, wherein the second light boundary is closer to the optical projection apparatus than the first light boundary, and the second light boundary is inclined towards the light reflector relative to a connecting line of the light source and an edge of an effective area of the optical projection apparatus, or coincides with the connecting line of the light source and the edge of the effective area of the optical projection apparatus.

4. The optical illumination assembly according to claim 3, wherein the printed circuit board is inclined 1 degree to 15 degrees relative to the optical axis.

5. The optical illumination assembly according to claim 1, wherein a focus region of the optical projection apparatus is at a rear edge of the reflective surface of the light reflector or in the vicinity thereof.

6. The optical illumination assembly according to claim 1, wherein the light reflector has a parabolic contour or an elliptical contour.

7. The optical illumination assembly according to claim 1, wherein a light beam projected by the optical projection apparatus forms a light distribution of a low beam function and/or high beam function.

8. A lighting device, comprising an optical illumination assembly, wherein the optical assembly includes a light source and a printed circuit board, the light source being arranged on the printed circuit board and emitting light, a light reflector, the light reflector being provided with a reflective surface, the reflective surface being configured to collect light emitted by the light source, and reflect the light in a light beam along an optical axis of the optical illumination assembly, and an optical projection apparatus, the optical projection apparatus being configured to project the light beam, wherein the light source is provided with a main light-emitting range, and the printed circuit board is inclined towards the light reflector relative to the optical axis, to prevent light emitted by the light source within the main light-emitting range from directly reaching the optical projection apparatus and being projected.

9. A motor vehicle, comprising a lighting device, wherein th lighting device includes an optical assembly that includes a light source and a printed circuit board, the light source being arranged on the printed circuit board and emitting light, a light reflector, the light reflector being provided with a reflective surface, the reflective surface being configured to collect light emitted by the light source, and reflect the light in a light beam along an optical axis of the optical illumination assembly, and an optical projection apparatus, the optical projection apparatus being configured to project the light beam, wherein the light source is provided with a main light-emitting range, and the printed circuit board is inclined towards the light reflector relative to the optical axis, to prevent light emitted by the light source within the main light-emitting range from directly reaching the optical projection apparatus and being projected.
